(19) United States
(12) Patent Application Publication
(10) Pub. No.: US 2023/0326475 A1
(43) Pub. Date: Oct. 12, 2023

(54) Apparatus, Methods and Computer Programs for Noise Suppression

(71) Applicant: Nokia Technologies Oy, Espoo (FI)

(72) Inventors: Paschalis Tsiaflakis, Heist-op-den-Berg (BE); Wouter LANNEER, Antwerp (BE)

(21) Appl. No.: 18/128,535

(22) Filed: Mar. 30, 2023

(30) Foreign Application Priority Data
Apr. 6, 2022 (GB) 2205022.3

(51) Int. Cl. G10L 21/0232; G10L 25/30

(52) U.S. Cl. CPC G10L 21/0232; G10L 25/30

(57) ABSTRACT

Examples of the disclosure enable tuning of the noise suppression in audio signals such as microphone captured signals. In examples of the disclosure, a machine learning program can be used to obtain outputs for a plurality of different frequency bands. One or more tuning parameters can also be obtained. The outputs can be processed to determine at least one uncertainty value and a gain coefficient for the plurality of different frequency bands. The at least one uncertainty value provides a measure of uncertainty for the gain coefficient, and the gain coefficient is adjusted by the at least one uncertainty value and the one or more tuning parameters. The adjusted gain coefficient is configured to be applied to a signal associated with at least one microphone output signal within the plurality of different frequency bands to control noise suppression for speech audibility.

### TECHNOLOGICAL FIELD

Examples of the disclosure relate to apparatus, methods and computer programs for noise suppression. Some relate to apparatus, methods and computer programs for noise suppression in microphone output signals.

### BACKGROUND

Processes that are used for noise suppression in microphone output signals can be optimized for different objectives. For example, a first type of process for the removal of residual echo and/or noise suppression could provide high levels of noise suppression but this might result in distortion of desired sounds such as speech. Conversely a process that retains the desired sound, for example by minimizing speech distortion, could have less noise suppression.

### BRIEF SUMMARY

According to various, but not necessarily all, examples of the disclosure there is provided an apparatus comprising means for:
using a machine learning program to obtain two or more outputs for at least one of a plurality of different frequency bands;
obtaining one or more tuning parameters;
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted by the at least one uncertainty value and the one or more tuning parameters; and
wherein the adjusted gain coefficient is configured to be applied to a signal associated with at least one microphone output signal within the at least one of the plurality of different frequency bands to control noise suppression for speech audibility.

The machine learning program may be configured to target different output objectives for the two or more outputs.

The two or more outputs of the machine learning program may comprise gain coefficients that correspond to the two or more output objectives.

Controlling the noise suppression for speech audibility may comprise adjusting noise reduction and speech distortion relative to each other.

The signal may comprise at least one of: speech; and noise.

The machine learning program may be configured to target different output objectives for the two or more outputs by using different functions corresponding to the different output objectives wherein the different functions comprise different values for one or more objective weight parameters.

A first value for the one or more objective weight parameters may prioritize noise reduction over avoiding speech distortion and a second value for the one or more objective weight parameters may prioritize avoiding speech distortion over noise reduction.

The gain coefficient may be determined based on a mean of the two or more outputs of the machine learning program and the at least one uncertainty value.

The at least one uncertainty value may be based on a difference between two or more outputs of the machine learning program.

The one or more tuning parameters may control one or more variables of the adjustment used to determine the gain coefficient.

The adjustment of the gain coefficient by the at least one uncertainty value and one or more tuning parameters may comprise a weighting of the two or more outputs of the machine learning program.

The means may be for using different tuning parameters for different frequency bands.

The means may be for using different tuning parameters for different time intervals.

The machine learning program may be configured to receive a plurality of inputs, for one or more of the plurality of different frequency bands, wherein the plurality of inputs comprise any one or more of: an acoustic echo cancellation signal, a loudspeaker signal, a microphone signal, and a residual error signal.

The machine learning program may comprise a neural network circuit.

The means may be configured to adjust the tuning parameter based on any one or more of, a user input, a determined use case, a determined change in echo path, determined acoustic echo cancellation measurements, wind estimates, signal noise ratio estimates, spatial audio parameters, voice activity detection, nonlinearity estimation, and clock drift estimations.

The means may be for using the machine learning program to obtain two of more outputs for each of the plurality of different frequency bands.

The signal associated with at least one microphone output signal may comprise at least one of: a raw at least one microphone output signal; a processed at least one of microphone output signal; and a residual error signal.

The signal associated with at least one microphone output signal may be a frequency domain signal.

According to various, but not necessarily all, examples of the disclosure there may be provided an electronic device comprising an apparatus as claimed in any preceding claim wherein the electronic device is at least one of: a telephone, a camera, a computing device, a teleconferencing device, a television, a virtual reality device, an augmented reality device.

According to various, but not necessarily all, examples of the disclosure there may be provided a method comprising:
using a machine learning program to obtain two or more outputs for at least one of a plurality of different frequency bands;
obtaining one or more tuning parameters;
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted by the at least one uncertainty value and the one or more tuning parameters; and
wherein the adjusted gain coefficient is configured to be applied to a signal associated with at least one microphone output signal within the at least one of the plurality of different frequency bands to control noise suppression for speech audibility.

According to various, but not necessarily all, examples of the disclosure there may be provided a computer program comprising computer program instructions that, when executed by processing circuitry, cause:
using a machine learning program to obtain two or more outputs for at least one of a plurality of different frequency bands;
obtaining one or more tuning parameters;
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted by the at least one uncertainty value and the one or more tuning parameters; and
wherein the adjusted gain coefficient is configured to be applied to a signal associated with at least one microphone output signal within the at least one of the plurality of different frequency bands to control noise suppression for speech audibility.

According to various, but not necessarily all, examples of the disclosure there may be provided an apparatus comprising means for:
using a machine learning program to obtain two or more outputs wherein the machine learning program is configured to target different output objectives for the two or more outputs;
processing the two or more outputs to determine an uncertainty value and a combined output; and
wherein the combined output is adjusted by the uncertainty value and one or more tuning parameters.

### BRIEF DESCRIPTION

Some examples will now be described with reference to the accompanying drawings in which:

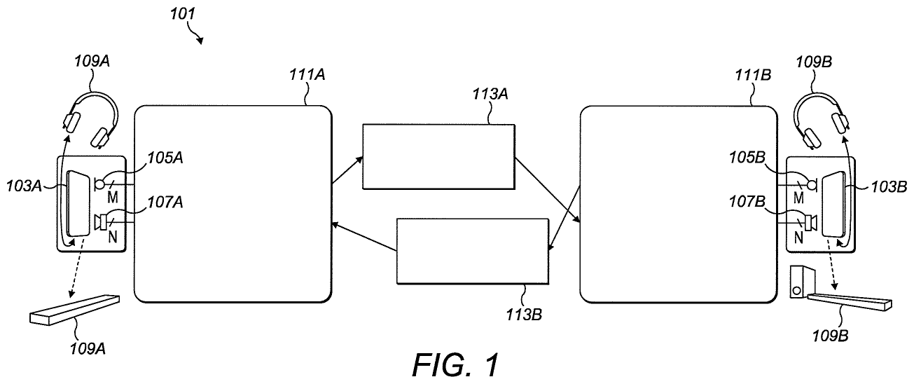

FIG. 1 shows an example system;

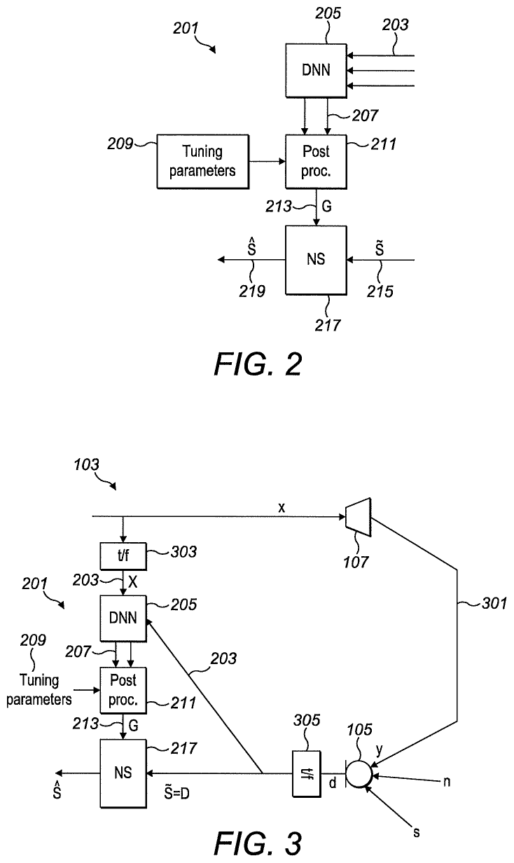

FIG. 2 shows an example noise reduction system;

FIG. 3 shows an example user device;

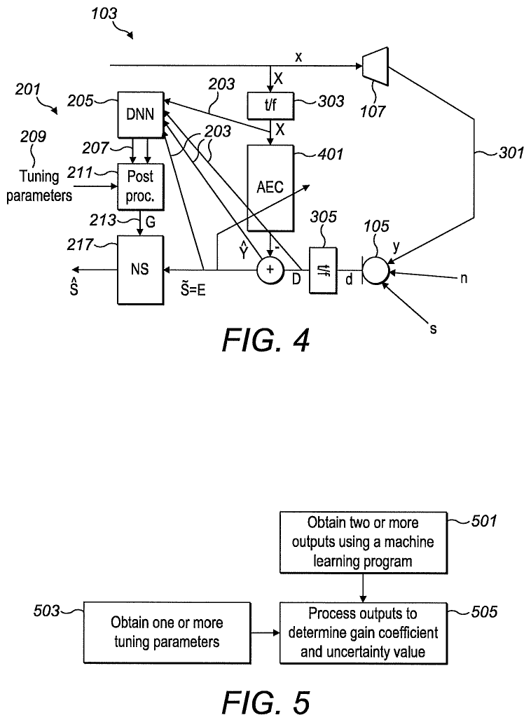

FIG. 4 shows an example acoustic echo cancellation system;

FIG. 5 shows an example method;

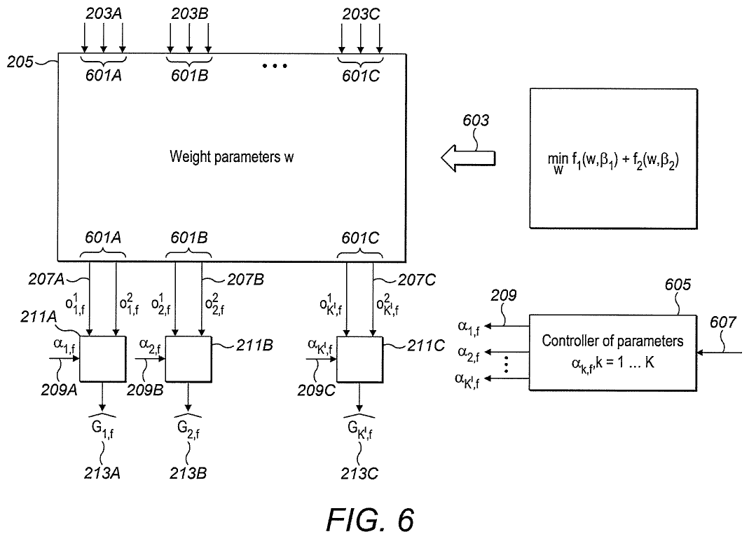

FIG. 6 shows inputs and outputs of a machine learning program;

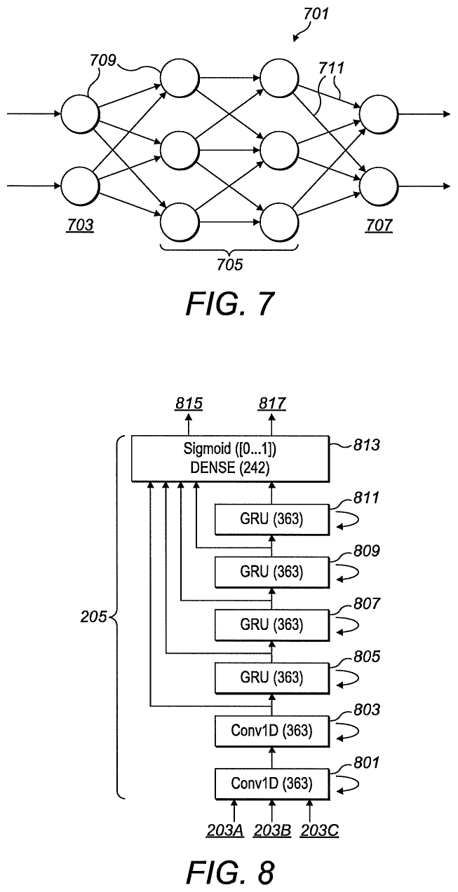

FIG. 7 shows an example machine learning program;

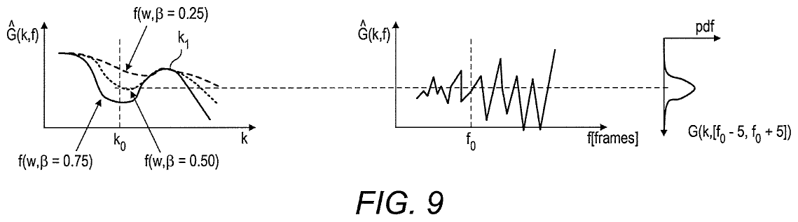

FIG. 8 shows another example machine learning program FIG. 9 shows gain coefficient predictions;

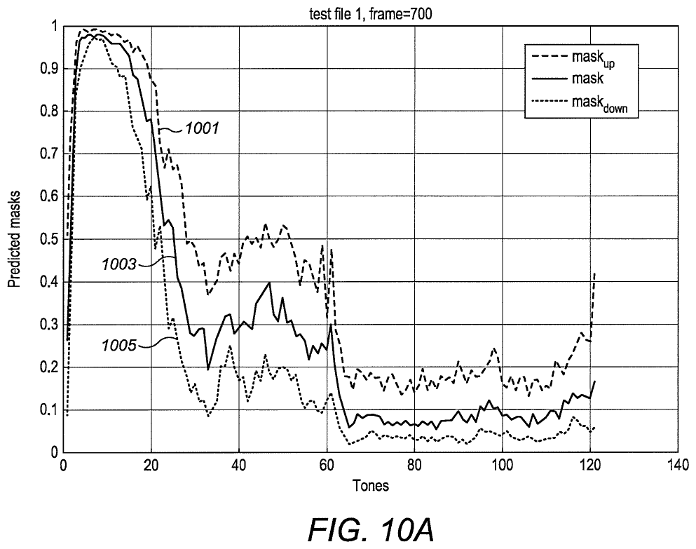

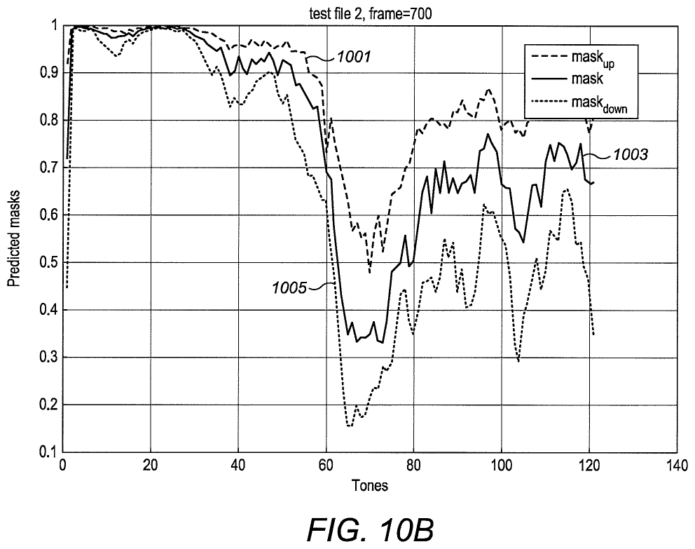

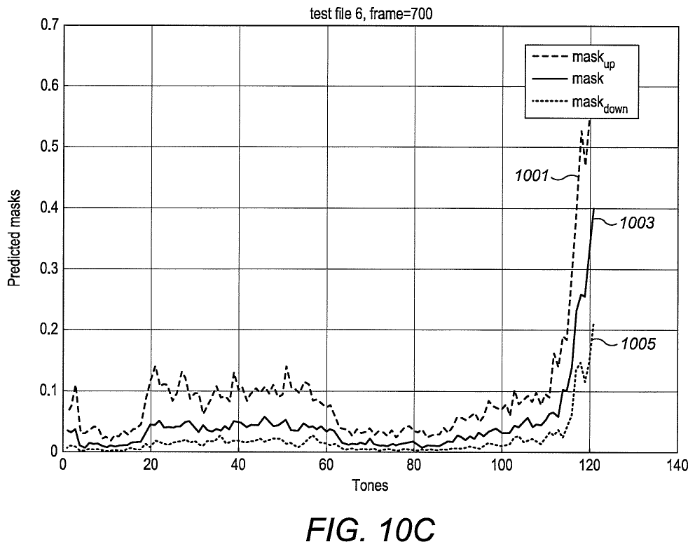

FIGS. 10A to 10C show gain coefficients for different audio settings;

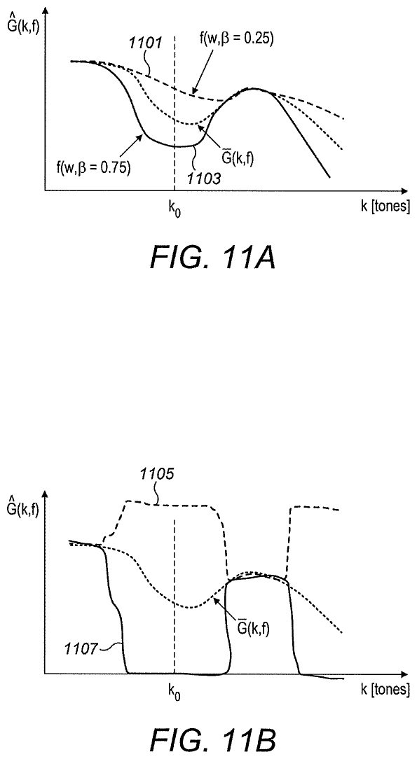

FIGS. 11A and 11B predicted gain coefficients adjusted using tuning parameters;

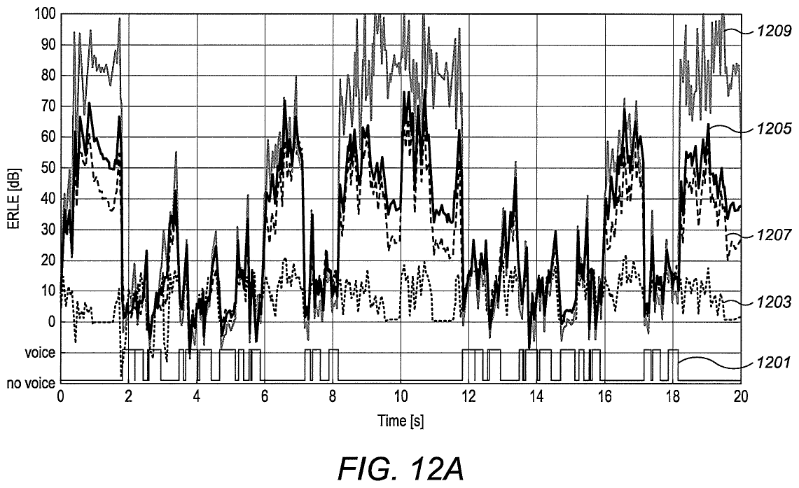

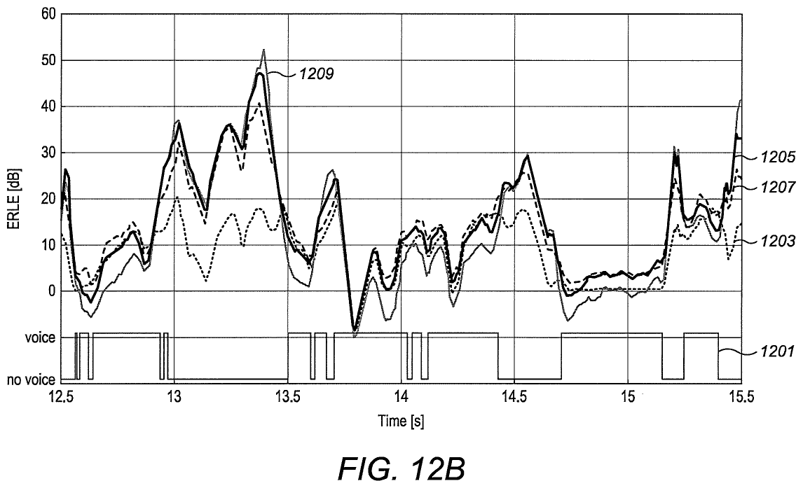

FIGS. 12A and 12B show plots of ERLE performances;

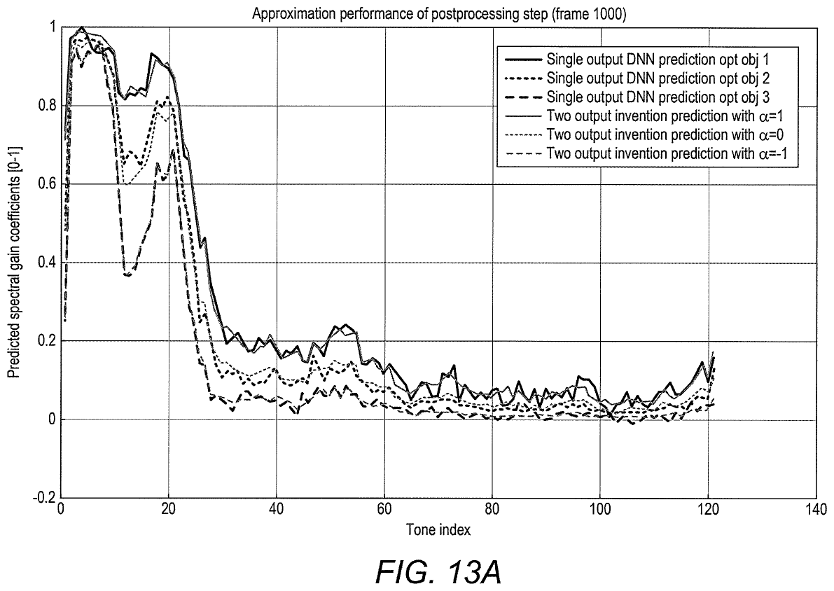

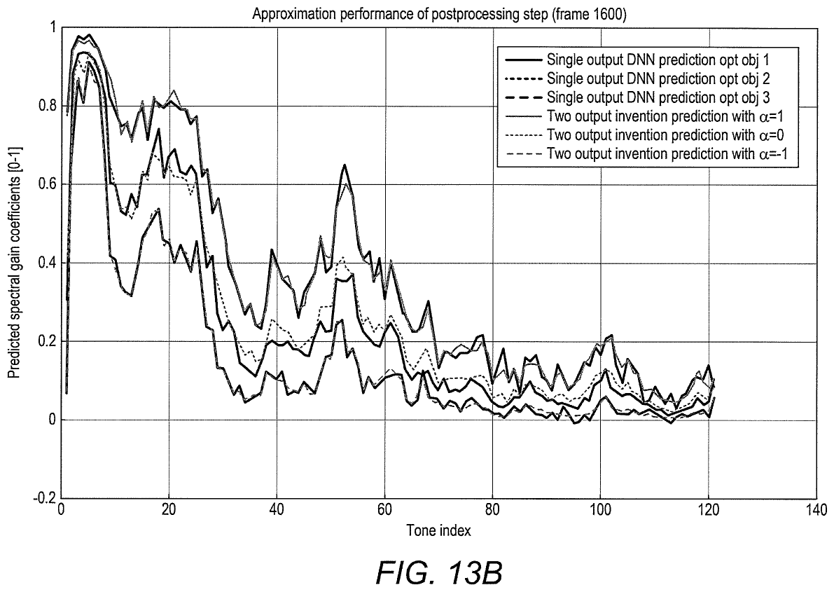

FIGS. 13A and 13B show predicted gain coefficients for different tuning parameters; and

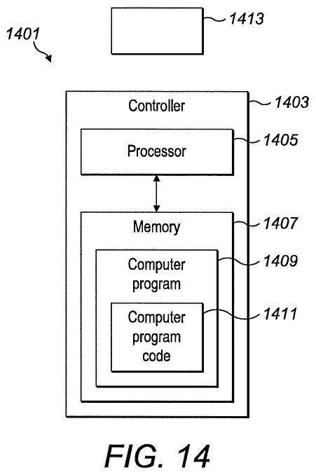

FIG. 14 shows an example apparatus.

### DETAILED DESCRIPTION

Examples of the disclosure enable tuning of the noise suppression in audio signals such as microphone captured signals. The microphone captured signals can comprise a mix of desired speech and noise signals. Other types of desired sound could also be captured. The noise signals can comprise undesired echoes from loudspeaker playback that occurs simultaneously with the microphone capture. These echoes can also be attenuated or partially removed by a preceding acoustic echo cancellation functionality. The tuning of the noise suppression can take into account different criteria or objectives for the noise suppression and speech audibility, and can effectively trade-off speech distortion against noise reduction. For example, a first objective could be to maximize, or substantially maximize, noise reduction at the expense of desired speech distortion while a second objective could be to minimize, or substantially minimize the desired speech distortion at the expense of weaker noise reduction. A third objective could be any intermediate trade-off point between the first and second objectives. The tuning of the noise suppression can enable systems and devices to be configured to take into account user preferences, the types of application being used and/or any other suitable factors.

FIG. 1 shows an example system 101 that could be used to implement examples of the disclosure. Other systems and variations of this system could be used in other examples. The system 101 can be used for voice or other types of audio communications. Audio from a near end user can be detected, processed and transmitted for rendering and playback to a far end user. In some examples, the audio from a near-end user can be stored in an audio file for later use.

The system 101 comprises a first user device 103A and a second user device 103B. In the example shown in FIG. 1 each of the first user device 103A and the second user device 103B comprise mobile telephones. Other types of user devices 103 could be used in other examples of the disclosure. For example, the user devices 103 could be a telephone, a camera, a computing device, a teleconferencing device, a television, a Virtual Reality (VR)/Augmented Reality (AR) device or any other suitable type of communications device.

The user devices 103A, 103B comprise one or more microphones 105A, 105B and one or more loudspeakers 107A, 107B. The one or more microphones 105A, 105B are configured to detect acoustic signals and convert acoustic signals into output electrical audio signals. The output signals from the microphones 105A, 105B can provide a near-end signal or a noisy speech signal. The one or more loudspeakers 107A, 107B are configured to convert an input electrical signal to an output acoustic signal that a user can hear.

The user devices 103A, 103B can also be coupled to one or more peripheral playback devices 109A, 109B. The playback devices 109A, 109B could be headphones, loudspeaker set ups or any other suitable type of playback devices 109A, 109B. The playback devices 109A, 109B can be configured to enable spatial audio, or any other suitable type of audio to be played back for a user to hear. In examples where the user devices 103A, 103B are coupled to the playback devices 109A, 109B the electrical audio input signals can be processed and provided to the playback devices 109A, 109B instead of to the loudspeaker 107A, 107B of the user device 103A, 103B.

The user devices 103A, 103B also comprise audio processing means 111A,111B. The processing means 111A,111B can comprise any means suitable for processing audio signals detected by the microphones 105A, 105B and/or processing means 111A,111B configured for processing audio signals provided to the loudspeakers 107A, 107B and/or playback devices 109A, 109B. The processing means 111A,111B could comprise one or more apparatus as shown in FIG. 14 and described below or any other suitable means.

The processing means 111A,111B can be configured to perform any suitable processing on the audio signals. For example, the processing means 111A,111B can be configured to perform acoustic echo cancellation, spatial capture, noise reduction, dynamic range compression and any other suitable process on the signals captured by the microphones 105A, 105B. The processing means 111A,111B can be configured to perform spatial rendering and dynamic range compression on input electrical signals for the loudspeakers 107A, 107B and/or playback devices 109A, 109B. The processing means 111A,111B can be configured to perform other processes such as active gain control, source tracking, head tracking, audio focusing, or any other suitable process.

The processed audio signals can be transmitted between the user devices 103A, 103B using any suitable communication networks. In some examples the communication networks can comprise 5G or other suitable types of networks. The communication networks can comprise one or more codecs 113A, 113B which can be configured to encode and decode the audio signals as appropriate. In some examples the codecs 113A, 113B could be IVAS (Immersive Voice Audio Systems) codecs or any other suitable types of codec.

FIG. 2 shows an example noise reduction system 201. The noise reduction system 201 could be provided within the user devices 103A, 103B as shown in FIG. 1 or any other suitable devices. The noise reduction system 201 can be configured to remove noise from microphone output signals 215 or any other suitable type of signals. The microphone output signals 215 could comprise noisy speech signals. The noisy speech signals could comprise both desired and undesired noise components.

The noise reduction system 201 comprises a machine learning program 205, a post processing block 211 and a noise suppression block 217. Other blocks or modules could be used in other examples of the disclosure.

The machine learning program 205 could be a deep neural network or any other suitable type of machine learning program 205. The machine learning program 205 can be configured to receive a plurality of inputs 203.

The inputs 203 that are received by the machine learning program 205 can comprise any suitable inputs. The inputs could comprise, far end signals, echo signals, microphone signals or any other suitable type of signals. The inputs 203 could comprise the original signals or processed versions of the signals or information obtained from one or more of the signals.

The inputs 203 for the machine learning program 205 can be received in the frequency domain.

The machine learning program 205 is configured to process the received inputs 203 to determine two or more outputs 207. In some examples the two or more outputs of the machine learning program 205 provide gain coefficients corresponding to two or more different output objectives. Other types of output can be provided in other examples of the disclosure.

The outputs 207 of the machine learning program 205 are provided as inputs to the post processing block 211. The post processing block 211 adjusts the outputs of the machine learning program 205 to generate an adjusted gain coefficient 213 that can be provided to the noise suppression block 217. For example, where the outputs of the machine learning program 205 comprise gain coefficients the post processing block can be configured to combine these different gain coefficients to generate an adjusted gain coefficient.

The post processing block 211 also receives one or more tuning parameters 209 as an input. The tuning parameters 209 can be used to control one or more of the variables of the adjustment that is applied by the post processing block 211 to determine the adjusted gain coefficient 213. The tuning parameters 209 can be selected or adjusted based on a user input, a determined use case, a determined change in echo path, determined acoustic echo cancellation measurements, wind estimates, signal noise ratio estimates, spatial audio parameters, voice activity detection, nonlinearity estimation, and clock drift estimations or any other suitable factor.

In some examples an uncertainty value can also be used to adjust the outputs of the machine learning program 205 to generate an adjusted gain coefficient 213. The uncertainty value can be based on a difference between the two or more outputs 207 of the machine learning program 205.

In some examples the adjustment of the outputs of the machine learning program 205 can comprise a weighting of the two or more outputs 207 of the machine learning program 205. The relative weights assigned to the respective outputs can be determined by the uncertainty parameter and the tuning parameters 209. Other types of functions can be used to determine the adjusted gain coefficient 213.

The adjusted gain coefficient 213 is provided to the noise suppression block 217. The noise suppression block 217 is configured to receive a microphone output signal 215 as an input and provide a noise suppressed signal 219 as an output. The microphone output signal 215 could be a noisy speech signal that comprises both desired speech, or other sounds, and unwanted noise.

The noise suppression block 217 can be configured to apply the adjusted gain coefficients 213 from the post processing block 211 to the microphone output signal 215. This can suppress noise within the microphone output signal 215. For example, it can remove residual echo components or other undesired noise.

The noise suppressed signal 219 can have some or all of the noise removed based on the gain coefficients that have been applied. In some examples the adjusted gain coefficients 213 can be adjusted to prioritize high noise reduction over avoiding speech distortion. In such cases there would be very little noise left in the noise suppressed signal 215. In some examples the adjusted gain coefficient 213 can be adjusted to prioritize low speech distortion over high noise reduction. In such cases there might be higher levels of noise remaining in the noise suppressed signals 219.

In some examples, the inputs 203 for the machine learning program 205 can be received in the time-domain. in such examples, the machine learning program 205 can be configured to transform the time-domain inputs 203 into an intermediate (self-learned) feature domain. The noise suppression block 217 can be configured to apply the adjusted gain coefficients 213 from the post processing block 211 to the microphone output signal 215 in the same intermediate (self-learned) feature domain.

FIG. 3 shows the example noise reduction system 201 within an example user device 103. The user device 103 comprises one or more loudspeakers 107 and one or more microphones 105 in addition to the noise reduction system 201.

Only one loudspeaker 107 and microphone 105 is shown in FIG. 3 but the user device 103 could comprise any number of loudspeakers 107 and/or microphones 105. In some examples one or more playback devices 109 could be used in place of, or in addition to the loudspeaker 107.

An echo path 301 exists between the loudspeakers 107 and the microphones 105. The echo path 301 can cause audio from the loudspeakers 107 to be detected by the microphones 105. This can create an unwanted echo within the near end signals provided by the microphones 105. The echo generated by the echo path 301 and detected by the microphone 105 is denoted as y in the example of FIG. 3. This is a time-domain signal.

A far end signal x is provided to the loudspeaker 107. The far end signal x is configured to control the loudspeaker 107 to generate audio. The user device 103 is also configured so that the far end signal x is provided as an input to a first time-frequency transform block 303. The first time-frequency transform block 303 is configured to change the domain of the far end signal x from the time domain to the frequency domain (for example, the Short-Time Fourier Transform (STFT) domain). In the example of FIG. 3 the far end signal is denoted as x in the time domain and X in the frequency domain.

The microphone 105 is configured to detect any acoustic signals. In this example the acoustic signals that are detected by the microphones 105 comprise a plurality of different components. In this example the plurality of different components comprise a speech component, (denoted as sin FIG. 3), a noise component (denoted as n in FIG. 3), and the echo (denoted as yin FIG. 3).

The microphone 105 detects the acoustic signals and provides an electrical microphone signal or near end signal which is denoted as din FIG. 3. The user device 103 comprises a second time-frequency transform block 305. The microphone signal d is provided as an input to the second time-frequency transform block 305. The second time-frequency transform block 305 is configured to change the domain of the microphone signal d to the frequency domain. The microphone signal is denoted as D in the frequency domain.

In this example the microphone signal D is the noisy speech signal \tilde{S} that is provided as an input to the noise suppression block 217. The noisy speech signal can be a signal that comprises speech and noise. The noise can be unwanted noise. The noise can be noise that affects the speech audibility.

In other examples additional processing could be performed on the microphone signal D or d before it is provided to the noise suppression block 217. For example, high-pass filtering, microphone response equalization or acoustic echo cancellation could be performed on the microphone signal D or d.

In the example of FIG. 3 the machine learning program 205 is configured to receive a plurality of different inputs 203. In this example the inputs 203 comprise the microphone signal D, which is the same as the noisy speech signal S for this case, and also the far-end signal X. In this example the inputs 203 for the machine learning program 203 are received in the frequency domain.

The machine learning program 205 is configured to process the received inputs 203 to determine two or more outputs 207. The outputs 207 are then processed by the post processing block 211 in accordance with the tuning parameters 209 to provide an adjusted gain coefficient 213. The adjusted gain coefficient 213 is used by the noise suppression block 217 to suppress noise within the microphone signal D and provide a noise suppressed signal as an output.

FIG. 4 shows another example user device 103 comprising both an example noise reduction system 201 and an acoustic echo cancellation block 401. The user device 103 also comprises one or more loudspeakers 107 and one or more microphones 105.

The acoustic echo cancellation block 401 could be configured to remove acoustic echoes from the microphone signal. In some examples, additional processing could be performed on the microphone signals before it is provided to the acoustic echo cancellation block.

Only one loudspeaker 107 and microphone 105 are shown in FIG. 4 but the user device 103 could comprise any number of loudspeakers 107 and/or microphones 105. In some examples one or more playback devices 109 could be used in place of, or in addition to the loudspeaker 107.

An echo path 301 exists between the loudspeakers 107 and the microphones 105. The echo path 301 can cause audio from the loudspeakers 107 to be detected by the microphones 103. This can create an unwanted echo within the near end signals provided by the microphones 105. The echo generated by the echo path 301 and detected by the microphone 105 is denoted as y in the example of FIG. 4. This is a time-domain signal.

A far end signal x is provided to the loudspeaker 107. The far end signal x is configured to control the loudspeaker 107 to generate audio. The user device 103 is also configured so that the far end signal x is provided as an input to a first time-frequency transform block 303. The first time-frequency transform block 303 is configured to change the domain of the far end signal x from the time domain to the frequency domain (for example, the Short-Time Fourier Transform (STFT) domain). In the example of FIG. 4 the far end signal is denoted as x in the time domain and X in the frequency domain.

The user device 103 also comprises an acoustic echo cancellation block 401. The echo cancellation block 401 can be a weighted overlap add (WOLA) based acoustic echo cancellation block 401 or could use any other suitable types of filters and processes.

The acoustic echo cancellation block 401 is configured to generate a signal corresponding to the echo y which can then be subtracted from the near end signals. The user device 103 is configured so that the acoustic echo cancellation block 401 receives the frequency domain far-end signal X as an input and provides a frequency domain echo signal Ŷ as an output.

The microphone 105 is configured to detect any acoustic signals. In this example the acoustic signals that are detected by the microphones 105 comprise a plurality of different components. In this example the plurality of different components comprise a speech component, (denoted as s in FIG. 4), a noise component (denoted as n in FIG. 4), and the echo (denoted as yin FIG. 4).

The microphone 105 detects the acoustic signals and provides an electrical microphone signal or near end signal which is denoted as din FIG. 4. The user device 103 comprises a second time-frequency transform block 305. The microphone signal d is provided as an input to the second time-frequency transform block 305. The second time-frequency transform block 305 is configured to change the domain of the microphone signal d to the frequency domain. The microphone signal is denoted as D in the frequency domain.

The user device 103 is configured so that the frequency domain microphone signal D and the frequency domain echo signal Ŷ are combined so as to cancel the echo components within the frequency domain microphone signal D. This results in a residual error signal E. The residual error signal E is a frequency domain signal. The residual error signal E is an audio signal based on the microphone signals but comprises a noise component N, a speech component S and a residual echo component R. The residual echo component R exists because the acoustic echo cancellation block 401 is not perfect at removing the echo Y and a residual amount will remain.

The user device 103 in FIG. 4 also comprises a noise reduction system 201. The noise reduction system 201 can be as shown in FIG. 2 or 3 or could be any other suitable type of noise reduction system 201.

The noise reduction system 201 comprises a machine learning program 205 that is configured to receive a plurality of inputs 203. The inputs 203 that are received by the machine learning program 205 can comprise any suitable inputs 203. In the example of FIG. 4 the machine learning program 205 is configured to receive the far-end signal X, the echo Ŷ, the microphone signal D, and the echo signal E as inputs. The machine learning program 205 could be configured to receive different inputs in other examples. In the example of FIG. 4 the inputs 203 for the machine learning program 205 are received in the frequency domain.

The machine learning program 205 is configured to process the received inputs 203 to determine two or more outputs 207. The outputs 207 are then processed by the post processing block 211 in accordance with the tuning parameters 209 to provide an adjusted gain coefficient 213.

The adjusted gain coefficient 213 is provided in a control signal to the noise suppression block 217. The noise suppression block 217 is configured to remove the residual echo components R and the unwanted noise components N from the residual error signal E. The noise suppression block 217 is configured to receive the residual error signal E as an input. The control input can indicate gain coefficients 213 to be applied by the noise suppression block 217 to the residual error signal E or other suitable near end signal.

The output of the noise suppression block 211 is a residual echo and/or noise suppressed microphone signals comprising the speech component S. This signal can be processed for transmitting to a far end user.

FIG. 5 shows an example method that could be implemented using a system 101 as shown in FIG. 1, a noise reduction system 201 as shown in FIG. 2 and/or user devices 103 as shown in FIGS. 3 and 4. The method of FIG. 5 enables the gain coefficients that are provided by the machine learning program 205 to be tuned or adjusted to account for different target objectives.

The method comprises, at block 501, using a machine learning program 205 to obtain two or more outputs. The machine learning program 205 can be configured to process one or more inputs in order to obtain the two or more outputs. The one or more inputs can be associated with a microphone output signal, for example the inputs can comprise the microphone output signal itself, information obtained from the least one microphone output signal, a processed version of the least one microphone output signal or any other suitable input. The at least one microphone signal could comprise a noisy speech signal or any other suitable signal.

The two or more outputs can be provided for different frequency bands. That is, a different set of two or more outputs can be provided for each of a plurality of different frequency bands.

The machine learning program 205 can comprise a neural network circuit, such as a deep neural network, or any other suitable type of machine learning program.

The machine learning program 205 can be configured to receive a plurality of inputs. The plurality of inputs can comprise any suitable inputs that enable the appropriate outputs to be obtained. The inputs can be received for each of the plurality of different frequency bands so that different data is provided as an input for different frequency bands. The plurality of inputs can comprise any one or more of: an acoustic echo cancellation signal Ŷ, a loudspeaker signal X, a microphone signal D, and a residual error E signal or any other suitable inputs. The inputs signals can be provided in the frequency domain. In some examples the inputs provided to the machine learning program 205 can be based on these signals so that there could be some processing or formatting of these signals before there are provided as inputs to the machine learning program 205. For instance, the input signals could be processed into a specific format for processing by the machine learning program 205. In some examples, the inputs for the machine learning program 205 are received in the time-domain. In such examples the machine learning program 205 can be configured to transform the time-domain inputs into an intermediate (self-learned) feature domain.

The machine learning program 205 can be pre-configured or pre-trained offline prior to use of the acoustic noise reduction system 201. Any suitable means or process can be used to train or configure the machine learning program 205.

The machine learning program 205 can be pre-configured or pre-trained to target different output objectives for the two or more outputs. That is each of the different outputs for each of the different frequency bands can be targeted towards a different output objective.

In some examples the two or more outputs of the machine learning program 205 can comprise gain coefficients corresponding to the two or more output objectives for which the machine learning program 205 is configured. For example, a first output could be the gain coefficient that would be provided if the machine learning program 205 was optimised for noise reduction with minimum speech distortion and a second output would be the gain coefficient that would be provided if the machine learning program 205 was optimised for maximum noise reduction at the expense of speech distortion.

The machine learning program 205 can be trained or configured to target different output objectives for the two or more outputs by using different objective functions. The different objective functions can comprise different objective weight parameters. The objective weight parameters can be configured such that a first value for the one or more objective weight parameters prioritizes a first objective over a second objective and a second value for the one or more objective weight parameters prioritizes the second objective over the first objective. The first objective could be noise reduction and the second objective could be speech distortion. Other objectives could be used in other examples of the disclosure.

At block 503 the method comprises obtaining one or more tuning parameters 209.

The tuning parameters 209 can comprise any parameters that can be used to adjust the outputs of the machine learning program 205. In some examples the tuning parameters 209 could be used to control one or more of the variables of a function that is used to adjust the outputs of the machine learning program 205.

The tuning parameters 209 can be tuned. That is, the values of the tuning parameters 209 can be changed. Any suitable means can be used to select or adjust the values of the tuning parameters 209. For instance, in some examples the tuning parameters 209 could be selected in response to a user input. In such cases a user could make a user input indicating whether they want to prioritize high noise reduction or avoiding speech distortion. In some examples the tuning parameters could be selected based on a detected use case of the user device 103. For example, if it is detected that the user device 103 is being used for a private voice call then tuning parameters 209 that enable high noise suppression could be selected to prevent noise from the environment being heard by the other users in the call. Other factors that could be used to select or adjust the tuning parameters 209 could be a determined change in echo path, determined acoustic echo cancellation measurements, wind estimates, signal noise ratio estimates, spatial audio parameters, voice activity detection, nonlinearity estimation, and clock drift estimations or any other suitable factor.

At block 505 the method comprises processing the two or more outputs of the machine learning program 213 to determine at least one uncertainty value and a gain coefficient. The uncertainty value and the gain coefficient can be determined for the different frequency bands. Different frequency bands can have different uncertainty values and gain coefficients.

The gain coefficient is configured to be applied to a signal associated with a microphone output signal 215 within the appropriate frequency bands to control noise suppression. The noise suppression can be controlled for speech audibility. In some examples the microphone output signal 215 could be a noisy speech signal that comprises both desired speech, or other sounds, and unwanted noise as shown in FIG. 2 or in any other suitable cases.

In some examples the signal to which the gain coefficients are applied could be the same as one of the inputs to the machine learning program 205. For example, the signal to which the gain coefficients are applied could be the microphone output signal itself or a processed version of the least one microphone output signal or any other suitable signal.

In some examples the gain coefficient could be applied to the microphone signals D as shown in FIG. 3 or in any other suitable implementation. In some examples the gain coefficient could be applied to a residual error signal E as shown in FIG. 4 or as in any other suitable implementation. In this case the microphone output signal comprises a microphone signal from which echo has been removed or partially removed. The signal to which the gain coefficients are applied can be a frequency domain signal. In some examples, the signal to which the gain coefficients are applied can be a time-domain signal that has been transformed into an intermediate (self-learned) feature domain.

The gain coefficient can be determined from any suitable function or process applied to the outputs of the machine learning program 205. In some examples the gain coefficient can be determined based on a mean of the two or more outputs of the machine learning program 205 and the at least one uncertainty value.

The at least one uncertainty value provides a measure of uncertainty for the gain coefficient. The uncertainty value can provide a measure of confidence that the gain coefficients provide an optimal, or substantially optimal, noise suppression output. The at least one uncertainty value can be based on a difference between the two or more outputs of the machine learning program 205 or any other suitable comparison of the outputs of the machine learning program 205.

The gain coefficient can be adjusted by the at least one uncertainty value and one or more tuning parameters 209. The tuning parameters 209 can control how much the gain coefficient is adjusted based on the target outputs that correspond to trade-offs between speech distortion and noise reduction. For instance, a tuning parameter 209 can be used to increase or decrease speech distortion relative to noise reduction based on whether or not speech distortion is tolerated in the target output. Similarly, a tuning parameter 209 can be used to increase or decrease noise reduction compared to speech distortion based on whether or not noise reduction is emphasized in the target output.

In some examples the tuning parameters 209 control one or more variables of the adjustment used to determine the gain coefficient. For example, the tuning parameters 209 can determine if the gain coefficient is tuned towards one target output or towards another target output.

In some examples the adjustment of the gain coefficient by the at least one uncertainty value and one or more tuning parameters 209 can comprise a weighting of the two or more outputs of the machine learning program 205. In such examples the tuning parameters 209 can determine the relative weightings of the respective outputs. The tuning parameters 209 can determine if the gain coefficient is weighted in a direction of a first output of the machine learning program 205 or a second output of the machine learning program 205.

In some examples the same tuning parameters 209 can be used for all of the frequency bands. In other examples different tuning parameters 209 can be used for different frequency bands. This can enable different frequency bands to be tuned towards different target outputs. This can be useful if the speech or other desired sounds are dominant in particular frequency bands and/or if the unwanted noise is dominant in specific frequency bands.

In some examples the same tuning parameters 209 can be used for all of the time intervals. In other examples different tuning parameters 209 can be used for different time intervals. This can enable different time intervals to be tuned towards different target outputs. This can be useful if the speech or other desired sounds that are dominant have quiet time intervals.

The tuning parameters 209 can be adjustable so that they can be controlled or adjusted by a user or any other suitable input. In some examples this can enable the tuning parameters 209 to be adjusted so that different values of the tuning parameters 209 can be used at different times. In some examples the adjusting of the tuning parameters 209 can enable the noise suppression to be configured for user preferences or other settings. The tuning parameters 209 can be adjusted in response to, or based on of, a user input, a determined use case, determined change in echo path, determined acoustic echo cancellation measurements, wind estimates, signal noise ratio estimates, spatial audio parameters, voice activity detection, nonlinearity or clock drift estimation or any other suitable factor.

Adjusting the tuning parameters 209 can change the value of the gain coefficient by changing the relative weightings of the outputs of the machine learning program 205 in the functions used to determine the gain coefficient.

Controlling noise suppression can comprise adjusting noise reduction and speech distortion relative to each other. The relative balance between noise reduction and speech distortion can be controlled using the tuning parameters 209. This can be used to improve speech audibility.

Controlling noise suppression for speech audibility can comprise any processing that can improve the understanding, ineligibility, user experience, distortion, intelligibility, loudness, privacy or any other suitable parameter relating to the microphone output signals. The improvements in the speech audibility can be measured using parameters such as a Short-Time Objective Intelligibility (STOI) which provides a measure of speech intelligibility, a Perceptual Evaluation of Speech (PESQ) which provides a measure of speech quality, a signal-to-noise ratio, an ERLE (Echo Return Loss Enhancement), or any other suitable parameter. The STOI score indicates a correlation of short-time temporal envelopes between clean and separated speech. The STOI score can have a value between 0 and 1. This score has been shown to be correlated to human speech intelligibility scores. The PESQ score indicates a correlation of short-time temporal envelopes between clean and separated speech and can have a value between −0.5 and 4.5.

FIG. 6 schematically shows inputs and outputs for a machine learning program 205. The machine learning program 205 can be configured to provide gain coefficients for applying to noisy speech signals or other types of microphone output signals for the removal of noise or other unwanted components of an audio signal such as residual echo.

The machine learning program 205 is configured to receive a plurality of inputs 203A, 203B, 203C. The plurality of inputs can comprise any suitable sets of data values. The data values can be indicative of near end audio signals and/or far end audio signals. In some examples the plurality of inputs could comprise an acoustic echo cancellation signal Ŷ, a loudspeaker signal X, a microphone signal D, and an error E signal or any other suitable inputs.

The plurality of inputs 203A, 203B, 203C are provided for different frequency bands 601A, 601B, 601C. The frequency bands 601A, 601B, 601C can comprise any suitable divisions or groupings of frequency ranges. In some examples the frequency bands that are used could correspond to a short-term Fourier transform (STFT) uniform frequency grid. In such cases a single frequency band could correspond to a single sub-carrier of the STFT frequency bands. In some examples the frequency bands that are used could correspond to frequency scales such as BARK, OPUS, ERB or any other suitable scale. In such examples the frequency bands may be non-uniform so that smaller frequency bands are used for the lower frequencies. Other types of frequency band could be used in other examples of the disclosure.

The machine learning program 205 can comprise any structure that enables a processor, or other suitable apparatus, to use the input signals 203A, 203B, 203C to generate two or more outputs 207A, 207B, 207C for each of the frequency bands 601A, 601B, 601C.

The machine learning program 205 can comprise a neural network or any other suitable type of trainable model. The term “machine learning program 205” refers to any kind of artificial intelligence (AI), intelligent or other method that is trainable or tuneable using data. The machine learning program 205 can comprise a computer program. The machine learning program 205 can be trained or configured to perform a task, such as creating two or more outputs based on the received inputs, without being explicitly programmed to perform that task or starting from an initial configuration. The machine learning program 205 can be configured to learn from experience E with respect to some class of tasks T and performance measure P if its performance at tasks in T, as measured by P, improves with experience E. In these examples the machine learning program 205 can learn from previous outputs that were obtained for the same or similar inputs. The machine learning program 205 can also be a trainable computer program. Other types of machine learning models could be used in other examples.

Any suitable process can be used to train or to configure the machine learning program 205 The training or configuration of the machine learning program 205 can be performed using real world/or simulation data. The training of the machine learning program 205 can be repeated as appropriate until the machine learning program 205 has attained a sufficient level of stability. The machine learning program 205 has a sufficient level of stability when fluctuations in the outputs provided by the machine learning program 205 are low enough to enable the machine learning program 205 to be used to predict the gain coefficients for noise suppression and/or removal of residual echo. The machine learning program 205 has a sufficient level of stability when fluctuations in the predictions provided by the machine learning program 205 are low enough so that the machine learning program 205 provides consistent responses to test inputs.

In some examples the training of the machine learning program 205 can be repeated as appropriate until one or more parameters of the outputs have reached a pre-defined threshold and/or until a predefined accuracy has been attained and/or until any other suitable criteria are satisfied.

The machine learning program 205 can be configured to use weight configurations 603 to process the plurality of inputs 203A, 203B, 203C in the respective frequency bands 601A, 601B, 601C. The weight configurations 603 are associated with different objective functions ƒ₁ and ƒ₂ as shown in FIG. 6.

The first objective function ƒ₁ corresponds to a first output objective. The output objective can be a target criteria such as prioritizing noise reduction at the cost of speech distortion. The second objective function ƒ₂ corresponds to a second output objective. The second output objective can be different to the first output objective. The second output objective could be minimizing speech distortion at the cost of noise reduction.

The machine learning program 205 uses the weight configurations 603 to process the plurality of inputs 203A, 203B, 203C in the respective frequency bands 601A, 601B, 601C.

The machine learning program 205 program provides two outputs 207A, 207B, 207C for the respective different frequency bands 601A, 601B, 601C. In some examples the outputs 207A, 207B, 207C are provided for each of the different frequency bands 601A, 601B, 601C.

The outputs 207A, 207B, 207C can comprise outputs that are optimized, or substantially optimized, for the different output objectives. For example, a first output can correspond to the output that would be obtained if a first target criteria is to be prioritized and a second output can correspond to the output that would be obtained if a second target criteria is to be prioritized.

The outputs 207A, 207B, 207C can be provided as inputs to a post processing block 211A, 211B, 211C. In the example of FIG. 6 a different post processing block 211A, 211B, 211C is provided for respective different frequency bands 601A, 601B, 601C. The post processing blocks 211A, 211B, 211C can be configured to determine an uncertainty value and a gain coefficient 213A, 213B, 213C for the respective frequency bands 601A, 601B, 601C

The post processing blocks 211A, 211B, 211C are also configured to receive a tuning parameter 209A, 209B, 209C as an input. The tuning parameter 209A, 209B, 209C can be used to adjust the gain coefficient 213A, 213B, 213C.

In some examples the tuning parameters 209A, 209B, 209C can be used in combination with an uncertainty value, to adjust the gain coefficients 213A, 213B, 213C for the respective frequency bands 601A, 601B, 601C. The tuning can control the relative weighting of the respective outputs 207A, 207B, 207C within the functions used to determine the gain coefficients 213A, 213B, 213C.

In some examples a control block 605 can be configured to determine the tuning parameters 209A, 209B, 209C that are to be used. The control block 605 can receive a control input 607 and provide information indicative of the tuning parameters 209A, 209B, 209C that are to be used as an output. The tuning parameters 209A, 209B, 209C that are to be used can be selected or determined based on the control input 607.

The control input 607 could be any suitable type of input. In some examples the control input 607 could be based on a user selection. For instance, a user could select a preferred setting in a user interface or via any other suitable means. This could then provide a control input indicative of the user preferences. In some examples the control input 607 could be based on a particular application or type of application is being used. In such cases information indicative of the application in use could be provided within the control input 607.

In some examples the same tuning parameters 209A, 209B, 209C could be used for the respective frequency bands 601A, 601B, 601C. In other examples different tuning parameters 209A, 209B, 209C could be used for different frequency bands 601A, 601B, 601C. This could enable different objectives to be prioritized at different frequency bands 601A, 601B, 601C.

FIG. 7 schematically shows an example machine learning program 205. In this example the machine learning program 205 comprises a deep neural network 701. The deep neural network 701 comprises an input layer 703, and output layer 707 and a plurality of hidden input layers 705. The hidden input payers 705 are provided between the input layer 703 and the output layer 707. The example machine learning program 205 shown in FIG. 7 comprises two hidden input layers 705 but the machine learning program 205 could comprise any number of hidden input layers 705 in other examples.

Each of the layers within the machine learning program 205 comprise a plurality of nodes 709. The nodes 709 within the respective layers are connected together by a plurality of connections 711, or edges, as shown in FIG. 7. Each connection 711 represents a multiplication with a weight configuration. Within the nodes 709 of the hidden layers 705 and output layers 707 a nonlinear activation function is applied to obtain a multi-dimensional nonlinear mapping between the inputs and the outputs.

In examples of the disclosure the machine learning programs 205 are trained or configured to map one or more input signals to a corresponding output signal. The input signals can comprise any suitable inputs such as the echo signals Ŷ, the far end signals X, the residual error signals E, or any other suitable input signals. The output signals could comprise gain coefficient G. The gain coefficients could comprise spectral gain coefficients or any other suitable type of gain coefficients.

FIG. 8 shows an architecture that can be used for example machine learning program 205. The example architecture shown in FIG. 8 could be used for user devices 103 comprising a single loudspeaker 107 and a single microphone 105 and using a WOLA based acoustic echo cancellation block 401 as shown in FIG. 4. For example, the means for cancelling the echo from the near end signal can comprise WOLA based acoustic echo cancellation with a frame size of 240 samples and an oversampling factor of 3 with a 16 kHz sampling rate. Other configurations for the acoustic echo cancellation process can be used in other examples of the disclosure.

In this example the machine learning program 205 comprises a deep neural network. Other architectures for the machine learning program 205 could be used in other implementations of the disclosure.

In this example the output of the acoustic echo cancellation process is a residual error signal E. This can be a residual error signal E as shown in FIG. 4. The residual error signal E comprises STFT domain frames in 121 (=240/2+1) frequency bands. In this example only the first half of the spectrum is considered because the second half of the spectrum is the conjugate of the first half. Each of the frames in the residual error signal E are transformed to logarithmic powers and standardized before being provided as a first input 203A to the machine learning program 205.

The machine learning program 205 also receives a second input 203B based on the echo signal Ŷ. The second input 203B also comprises STFT domain frames in the same 121 frequency bands as used for the residual error signal E. The echo signal Ŷ can also be transformed to logarithmic powers and standardized before being provided as the second input 203B to the machine learning program 205.

In the example of FIG. 8 machine learning program 205 also receives a third input 203C based on the far end or loudspeaker signal X. The third input 203C also comprises STFT domain frames in the same 121 frequency bands as used for the residual error signal E. The far end or loudspeaker signal X can also be transformed to logarithmic powers and standardized before being provided as the third input 203C to the machine learning program 205.

Different input signals could be used in different examples of the disclosure. For instance, in some examples the third input 203C based on the far end or loudspeaker signal X might not be used. In other examples one or more of the respective input signals could be based on different information or data sets.

The standardized input signals as shown in FIG. 8 therefore comprise 363 input features. The 363 input features are passed through a first one dimensional convolutional layer 801 and second one dimensional convolutional layer 803. Each of the convolutional layers 801, 803 provide 363 outputs over the range of frequency bands. The first convolutional layer 801 has a kernel size of five and the second convolutional layer 803 has a kernel size of 3. Each of the convolutional layers 801, 803 has a stride of one. Other configurations for the convolutional layers could be used in other examples.

The convolutional layers 801, 803 are followed by four consecutive gated recurrent unit (GRU) layers 805, 807, 809, 811. Each of the GRU layers 805, 807, 809, 811 in this example provide 363 outputs.

The outputs of each of the GRU layers 805, 807, 809, 811 and the second convolutional layer 803 are provided as inputs to a dense output layer 813. The dense output layer 813 uses a sigmoid activation function to generate the two outputs 815, 817 of the machine learning program 205. In this example each of the outputs 815, 817 can comprise 121 values. In other examples the machine learning program 205 could provide more than two outputs.

Any suitable process can be used to train or configure the machine learning program 205 and determine the objective weight parameters 603 that should be used for each of the different objective functions. In some examples the training of the machine learning program 205 can use a data set comprising mappings of input data values to optimal outputs. The data set could comprise a synthetic loudspeaker and microphone signals. In some examples the dataset could comprise any available data base of loudspeaker and microphone signals.

To train the machine learning program 205 optimal or target gain coefficients are defined. Any suitable process or method can be used to define the optimal or target gain coefficients such as the ideal binary mask (IBM), the ideal ratio mask (IRM), the phase sensitive filter, the ideal amplitude mask or any other suitable process or method. These processes or methods are formulas that depend on perfect knowledge of the speech and noise or other wanted sounds. This perfect knowledge should be made available for the datasets that are used to train the machine learning program 205. This enables the optimal or target gain coefficients that should be predicted by the machine learning program 205 to be computed. For example, the optimal or target gain coefficients Gₒₚₜ(k, f) that should be predicted by the machine learning program 205 could be computed as:

$${G}_{o p t} ( k , f ) = \frac{\vert S ( k , f ) \vert}{\vert E ( k , f ) \vert} ,$$

where f denotes the frame index, k denotes the frequency band index, S(k, f) denotes the actual (complex-valued) speech that should remain after the noise suppression and removal of residual echo and E(k, f) denotes the residual error signal or a near end signal (or noisy speech signal) comprising the unwanted noise and residual echo.

The optimal or target gain coefficients Gₒₚₜ(k, n usually have a value between zero and one.

In cases where the target gain coefficients Gₒₚₜ(k, n are predicted perfectly by the machine learning program 205 the target gain coefficients Gₒₚₜ(k, n can be applied to the residual error signal E(k, n to provide a signal that has the same magnitude as the speech, but a different phase. That is,

Gₒₚₜ(k,f)E(k,f)=|S(k,f)|φ(E(k,f))

Where φ denotes the phase of the complex number. It can be assumed that the phase distortion is not perceived by a human listener in a significant manner. In cases, where the target gain coefficients Gₒₚₜ(k, f) are predicted imperfectly, the speech magnitudes are approximated.

In examples of the disclosure the machine learning program 205 is trained or configured to provide two different outputs. The difference between the different outputs provides an uncertainty value for the gain coefficient. The uncertainty value provides a measure of uncertainty for the gain coefficient. The uncertainty value can be considered for respective frequency bands. That is, different frequency bands can have different uncertainty values.

In some examples weight configuration optimization problems can be used to train or configure the machine learning program 205. The weight configuration optimization problems can be trained for objective functions ƒ₁(w, β₁) and ƒ₂(w, β₂), and for the first outputs oₖ¹, k=1, . . . , K′ and second outputs oₖ², k=1, . . . , K′. These outputs correspond to the two or more outputs of the machine learning program 205. The weight configuration optimization problems could be

$${min}_{w} {f}_{1} ( w , {β}_{1} ) + {f}_{2} ( w , {β}_{2} )$$

$$with$$

$${f}_{n} ( w , β ) = β {\sum }_{f} {\sum }_{k = 1}^{{K}^{′}} {[ max ( 0 , {o}_{k , f}^{n} ( w ) - {G}_{opt} ( k , f ) ) ]}^{2} + ( 1 - β ) {\sum }_{f} {\sum }_{k = 1}^{{K}^{′}} {[ max ( 0 , {G}_{opt} ( k , f ) - {o}_{k , f}^{n} ( w ) ) ]}^{2}$$

$${f}_{n} ( w , β ) = β {\sum }_{f} {\sum }_{k = 1}^{{K}^{′}} {[ max ( 0 , {o}_{k , f}^{n} ( w ) - {G}_{opt} ( k , f ) ) ]}^{2} + ( 1 - β ) {\sum }_{f} {\sum }_{k = 1}^{{K}^{′}} {[ max ( 0 , {G}_{opt} ( k , f ) - {o}_{k , f}^{n} ( w ) ) ]}^{2}$$

where w denotes the weight configurations of the machine learning program 213, β and (1−β₁) correspond to the (asymmetric) importance of the under and over-estimation error, with β₁≠β₂≥0. The parameters β₁ and β₂ are the objective weight parameters.

Different values of β give different objective functions and result in different weight configurations for the machine learning program 205. This will result in different outputs being provided by the machine learning program 205 based on the different objective functions that are used.

In cases where β=0.5 the function ƒₙ corresponds to a conventional mean square error objective function. In such cases the machine learning program 205 predicts the (short-term) mean performance of the gain coefficient for a frequency band and a time frame. However, due to non-perfect prediction and statistical variation of the optimal gain coefficients, there will be some frequency bands and time frames where the predicted gain coefficients will be larger than the optimal target gain coefficients, or smaller than the optimal target gain coefficients. A predicted gain coefficient that is larger than the optimal gain coefficient (over-estimation) will cause insufficient noise reduction (with less speech distortion) and a predicted gain coefficient that is smaller than the optimal gain coefficient (under-estimation) will cause too much noise reduction (and too much speech distortion).

In cases where β>0.5 an overestimate of the optimal gain coefficient is penalized more than an underestimate. If the machine learning program 205 can perfectly predict the optimal gain coefficients, then this would give the same results as β=0.5. However, if the machine learning program 205 gives imperfect predictions, this will result in a negatively-biased gain coefficients that rather tend to underestimate the target gain coefficients in case of uncertainty. That is, this will yield gain coefficients that rather maximize noise reduction at the cost of speech distortion.

In cases where β<0.5 an underestimate of the optimal gain coefficient is penalized more than an overestimate. If the machine learning program 205 can perfectly predict the optimal gain coefficients, then this would give the same results as β=0.5. However, if the machine learning program 205 gives imperfect predictions, this will result in a positively-biased gain coefficients that rather tend to overestimate the true optimal gain coefficients in case of uncertainty. That is, this will yield gain coefficients that rather minimize speech distortion at the cost of less noise reduction.

FIG. 9 conceptually shows gain coefficient predictions for different objective functions. The data used for the plots in FIG. 9 were obtained by using β₁=0.75, β₁=0.5 and β₁=0.25 to train or configure the weight configurations of a machine learning program 205 such as the machine learning program 205 in FIG. 8.

The left-hand plot in FIG. 9 shows the gain coefficients that are predicted by the machine learning program 205 for objective functions ƒ(w, β=0.25), ƒ(w, β=0.50) and ƒ(w, β=0.75). These are the outputs that would be provided by a machine learning program 205 that is trained or configured to provide a single output for the given objective. These outputs are not yet adjusted by an uncertainty value or a tuning parameter. In this plot the y axis represents the gain coefficients. These can take a value between zero and one. The x axis represents the frequency bands k.

In this plot the mean square error optimization is provided by the objective function ƒ(w, β=0.50). The objective function ƒ(w, β=0.25) has β<0.5 and the plot for this objective function shows that an underestimate of the optimal gain coefficient is penalized more than an overestimate. The resulting positive bias is only there for frequency bands where the predictions of the machine learning program 205 are less accurate. That is, there is no bias where the predictions of the machine learning program are accurate. The magnitude of the bias is proportional to the level of confidence in the estimated gain coefficients.

The objective function ƒ(w, β=0.75) has β>0.5. The plot for this objective function shows that an overestimate of the optimal gain coefficient is penalized more than an underestimate. The resulting negative bias is only there for frequency bands where the predictions of the machine learning program 205 are less accurate. That is, there is no bias where the predictions of the machine learning program 205 are accurate.

The magnitude of the bias is correlated to the level of confidence in the estimated gain coefficients. A large bias in the gain coefficients results in a large uncertainty value in outputs of a machine learning program 205.

The left-hand plot shows that there are different uncertainty values for different frequencies. At frequency k₀ there are large differences in the gain coefficients. There is a low level of confidence that the outputs of the machine learning program 205 provide an optimal gain coefficient. There would be a large uncertainty value at this frequency. There is a low level of confidence that the outputs of the machine learning program 205 provide an optimal gain coefficient. At the frequency k₁ there is no difference in the gain coefficients predicted using the different objective functions. At this frequency there is a high level of confidence that the outputs of the machine learning program 205 provide an optimal gain coefficient. In this case the uncertainty value is zero or very small.

The middle plot in FIG. 9 shows the variation in the gain coefficient over a number of time frames at frequency k₀. This shows that the predicted gain coefficient at frequency k₀ varies over time. The short-term variation in the gain coefficient cannot be predicted by the machine learning program 205 and results in a bias.

Where the variations are small the predictions of the gain coefficients made by the machine learning program 205 would still be accurate and so there would only be a small difference between the gain coefficients predicted by different objective functions ƒ(w, β=0.25) and ƒ(w, β=0.75). Where the variations are large the predictions of the gain coefficients made by the machine learning program 205 would be less accurate and there would be a larger difference between the gain coefficients predicted by different objective functions ƒ(w, β=0.25) and ƒ(w, β=0.75). The difference between the gain coefficients predicted by different objective functions ƒ(w, β=0.25) and ƒ(w, β=0.75) can provide the uncertainty value. This gives a measure of confidence in the respective outputs of the machine learning program 205.

The right-hand plot in FIG. 9 shows a probability density function for the predictive gain coefficients. This shows an indication of the level of confidence that the outputs of the machine learning program provide an accurate prediction for the gain coefficients.

In examples of the disclosure the outputs of the machine learning program 205 can be processed to provide a gain coefficient by determining a mean of the outputs of the machine learning program 205. In examples where the machine learning program 205 provides two outputs for the respective frequency bands the gain coefficient can be given by:

$$\overline{G} ( k , f ) = \frac{{o}_{k , f}^{1} ( w ) + {o}_{k , f}^{2} ( w )}{2}$$

The uncertainty value can be given by:

$$δ ( k , f ) = min ( 1 , max ( 0 , \frac{{o}_{k , f}^{2} ( w ) - {o}_{k , f}^{1} ( w )}{2} ) )$$

The examples given above can also be expanded to examples where the machine learning program 205 provides three outputs. For example, three different outputs can be obtained for the respective frequency ranges using objective functions with β₁=0.25, β₂=0.5, β₃=0.75. In such cases the gain coefficient can be given by:

G̅(k,f)=o_{k,f}²(w)

And the uncertainty value can be given by:

$$δ ( k , f ) = \{ \begin{matrix}min ( 1 , max ( 0 , {o}_{k , f}^{3} ( w ) - {o}_{k , f}^{2} ( w ) ) if {α}_{k , f} \geq 0 \\ min ( 1 , max ( 0 , {o}_{k , f}^{2} ( w ) - {o}_{k , f}^{1} ( w ) ) if {α}_{k , f} < 0\end{matrix}$$

Other formulas could be used in other examples.

FIGS. 10A to 10C show different gain coefficients or masks that can be generated by the machine learning program 205 for three different objective functions. In these examples a first plot 1001 represents the gain coefficients that are obtained with a first objective function ƒ(w, β=0.25), a second plot 1003 represents the gain coefficients that are obtained with a second objective function ƒ(w, β=0.5), and a third plot 1005 represents the gain coefficients that are obtained with a third objective function ƒ(w, β=0.75).

The data obtained for FIGS. 10A to 10C were obtained using a user device 103 as shown in FIG. 4 with different acoustic echo cancellation settings. The different acoustic echo cancellation settings can be different audio trace files or any other suitable settings.

FIGS. 10A to 10C show that for some frequency bands the predicted gain coefficients are very close to each other. For these frequency bands the confidence level in the predicted gain coefficients is high and the uncertainty value is low. For these frequency bands it can be expected that the machine learning program 205 accurately predicts optimal, or substantially optimal gain coefficients. This can provide small levels of speech distortion and good noise reduction or residual echo suppression for these frequency bands.

For other frequency bands there is large difference between the predicted gain coefficients and the respective plots are not very close to each other. For these frequency bands the confidence level in the predicted gain coefficients is low and the uncertainty value is high. For these frequency bands it can be expected that the machine learning program 205 does not accurately predict optimal, or substantially optimal gain coefficients.

In the above example the machine learning program 205 is trained or configured using two outputs. The example can be extended to three outputs by changing the training optimization problem to include three objective functions. For example, the training optimization program could be:

$${min}_{w} {f}_{1} ( w , {β}_{1} ) + {f}_{2} ( w , {β}_{2} ) + {f}_{3} ( w , {β}_{3} ) ,$$

where we can consider the following values: β₁=0.25, β₂=0.5, β₃=0.75

FIGS. 11A and 11B show how predicted gain coefficients can be adjusted using tuning parameters. Any suitable process can be used to adjust the gain coefficients. The process for adjusting the predicted gain coefficient can be applied by a post processing block 211 such as the post processing blocks 211 shown in the noise reduction systems 201 in FIGS. 2 to 4 or by any other suitable means.

In examples where the machine learning program 205 provides two outputs for the respective frequency bands the formulas given above can be used to determine the uncertainty value and a gain coefficient. The gain coefficient can then be tuned with a tuning parameter α_{k,f} to provide an adjusted gain coefficient. The adjusted gain coefficient can be given by

Ĝ_{k,f}=max(0, min(1,G̅_{k,f}+α_{k,f}δ(k,f)))

The adjusted gain coefficients Gₒₚₜ(k, f) can be applied to the noisy speech signal \tilde{S}(k, f) to provide a noise-suppressed signal

Ŝ(k,f)=Ĝ(k,f)\tilde{S}(k,f),∀k,f.

FIGS. 11A and 11B show example adjusted gain coefficients. The gain coefficients can have a value between zero and one.

FIG. 11A shows gain coefficients obtained using different tuning parameters α_{k,f}. A first plot 1101 is obtained with a first tuning parameter value of one. That is:

∀k:α_{k,f}=1

Plot 1101 shows that using this tuning parameter results in a higher gain coefficient with respect to the mean. That is, the gain coefficient will be closer to one. This adjusts the gain coefficient towards lower levels of speech distortion and reduced noise suppression. The tuning parameter increases the gain coefficient for the frequency bands that have a high uncertainty value but does not adjust the gain coefficient for the frequency bands with a zero or very low uncertainty value.

A second plot 1103 is obtained with a first tuning parameter value of minus one. That is:

∀k: α_{k,f}=−1

Plot 1103 shows that using this tuning parameter results in a lower gain coefficient with respect to the mean. That is, the gain coefficient will be closer to zero. This adjusts the gain coefficient towards increased levels of speech distortion and high noise suppression. The tuning parameter decreases the gain coefficient for the frequency bands that have a high uncertainty value but does not adjust the gain coefficient for the frequency bands with a zero or very low uncertainty value.

FIG. 11B shows gain coefficients obtained using tuning parameters α_{k,f} with a larger magnitude than the tuning parameters used in FIG. 11A. In FIG. 11B a first plot 1105 is obtained with a first tuning parameter value of ten. That is:

∀k:α_{k,f}=10

This is a very large value for the tuning parameter. The plot 1105 shows that this tuning parameter adjusts the gain coefficient towards a value of one for some frequency bands. In these frequency bands there would be no noise suppression at all. These frequency bands are the frequency bands for which the uncertainty value is high.

In this example, if there is a low certainty as to whether or not speech was present in the signal, the tuning parameters can be used to adjust the gain coefficients so that there is no suppression at all. This ensures that the noise suppression does not introduce any speech distortion. However, for time frames where there is no voice activity the machine learning program 205 can predict the gain coefficients with a high confidence and so the uncertainty value would be low or zero. For these time frames the tuning parameters would not cause an increase in the gain coefficients.

In FIG. 11B a second plot 1107 is obtained with a second tuning parameter value of minus ten. That is:

∀k:α_{k,f}=−10

This is a very large negative value for the tuning parameter. The plot 1107 shows that this tuning parameter adjusts the gain coefficient towards a value of zero for some frequency bands. In these frequency bands there would be very high noise suppression. This could ensure that there is no noise remaining in the signal. The high noise suppression could result in speech distortions. However, the high noise suppression would only be applied for frequency bands in which the uncertainty value is high.

In examples of the disclosure different tuning parameters α_{k,f} can be used for different frequency bands and/or different time frames. The tuning parameters α_{k,f} can be controlled by a user or any other suitable factor. For example, a user could indicate that they want higher noise suppression or lower noise suppression via a user input. This could determine the tuning parameters that are used. In other examples the tuning parameters that are used could be determined by the audio applications or any other suitable factors.

In some examples the tuning parameter could be indicated by the far end user. For instance, if a far end user is in an environment in which the find the background noise is annoying then they can select a setting to filter out more of the background noise.

In some examples the tuning parameter could be indicated by the near end user. For instance, if a near end user is in an environment that they want to keep private then they can select a setting to filter out more of the background noise. For example, they could be taking a work call at home and want to keep the noise of other family members out of the work call. In such cases the near end user could set the tuning parameters to prioritize noise reduction and filter out more of the background noise. This could be provided to the near end or far end user as a privacy setting or any other suitable type of audio setting.

In some cases the tuning parameters could be set automatically without any specific input from either a near end user or a far end user. In some cases the tuning parameters could be set based on the applications being used by, and/or the functions being performed by, the respective electronic devices and apparatus.

For instance, during initialization it can take some time for the acoustic echo cancellation process to converge and/or to determine the echo signals. In such cases the tuning parameters could be configured so that noise suppression is set higher during initialization. This will cancel the residual echo during initialization.

In some cases the tuning parameters could be configured so that noise suppression is set higher if it is determined that there is a sudden echo path change. For example, if there is a noise such as a door slamming or if the near end user moves to a different room. The higher noise suppression in these circumstances can suppress the larger residual echo during such circumstances.

In some cases the tuning parameters could be selected based on whether or not voice activity is detected. Any suitable means can be used to automatically detect whether or not voice activity is present. If voice activity is present then less aggressive noise reduction is used so as to avoid speech distortion. If voice activity is not present then more aggressive noise reduction is used so as to remove more unwanted noise.

In some examples the tuning parameters that are used can be selected based on factors relating to the acoustic echo cancellation process. For instance, if a fast RIR (Room impulse response) change is detected then the performance of the acoustic echo cancellation process will degrade. Therefore, if a fast RIR change is detected the tuning parameters can be set so as to enable more aggressive noise reduction and to suppress more of the residual echo.

In some cases a current ERLE performance could be estimated. The ERLE performance could be estimated based on leakage estimates or any other suitable factor. If it is determined that the ERLE is below a given threshold value this could act as a trigger to select tuning parameters to enable more aggressive noise reduction.

In some examples the tuning parameters that are used can be selected based on factors relating to signal to noise ratios. For instance, a detection of the noise setting of the user can be determined. This can identify if the user is at home, in a car, outside, in traffic, in an office or in any other type of environment. The tuning parameters could then be selected based on the expected noise levels for the determined environment of the user.

In some examples the signal to noise ratio can be determined. If there is a high signal to noise ratio then the tuning parameters can be selected to cause lower levels of noise suppression. If there is a low signal to noise ratio then the tuning parameters can be selected to cause higher levels of noise suppression.

In some cases the tuning parameters can be selected based on an estimation of nonlinearity for the system 101 or user devices 103. For example, the nonlinearity of the loudspeakers 107 and the microphones 105. If a high level of non-linearity is estimated then the tuning parameters can be selected to provide lower noise suppression as this will result in better speech intelligibility.

In some cases the tuning parameters can be selected based on an estimation of clock drift for the system 101 or user devices 103. For example, the clock drift of the loudspeakers 107 and the microphones 105. If a high level of clock drift is estimated then the tuning parameters can be selected to provide higher (or lower) noise suppression as this will result in better speech intelligibility.

In some cases the tuning parameters can be selected based on whether or not wind noise is detected. Any suitable means can be used to determine whether or not wind noise is detected. If wind noise is detected then the tuning parameters can be selected so as to increase noise suppression and reduce wind noise within the signal.

In some cases the tuning parameters can be selected based on factors relating to the spatial audio parameters. For instance, if the audio signals comprise spatial audio signals that indicate the presence of diffuse or non-localized sounds then the tuning parameters can be selected so as to increase or reduce the noise suppression depending on whether or not the diffuse sound is a wanted sound or an unwanted sound. For instance, in some examples the diffuse sounds could provide ambient noise which adds to the atmosphere of spatial audio. In other examples the diffuse sound might detract from the direct or localized sounds and might be unwanted noise.

In some examples other post processing can be applied to the gain coefficients for noise suppression. The additional post processing could comprise gain smoothing, loudness normalization, maximum energy decay (to avoid abrupt microphone muting) or any other suitable processes.

Examples of the disclosure provide the benefit that a single machine learning program 205 can be trained or configured offline with an architecture that consistently predicts a plurality of outputs for respective frequency bands. These outputs can be used to predict a gain coefficient and an uncertainty value for the gain coefficient. The predicted gain coefficient can then be adjusted to obtain an adjusted gain coefficient. The adjustment of the predicted gain coefficient can make use of tuning parameters which can enable different trade-offs with respective to different objectives. For example, higher noise suppression could be prioritized over preventing speech distortion or small levels of speech distortion could be prioritized over noise reduction.

FIGS. 12A and 12B show plots of ERLE (Echo Return Loss Enhancement) performances that are obtained using examples of the disclosure.

FIG. 12A shows the ERLE over a twenty second time frame. FIG. 12B shows the section between 12.5 seconds to 15.5 seconds in more detail.

In FIGS. 12A and 12B a first plot 1201 shows the time periods in which speech, or voice, is present. A second plot 1203 shows the signal with no noise suppression applied. A third plot 1205 is obtained with the tuning parameter set to zero (α=0). In this case there would be no adjustment of the gain coefficient predicted by the machine learning program 205.

A fourth plot 1207 is obtained with the tuning parameter set to two (α=2). This adjusts the gain coefficient predicted by the machine learning program 205 to increase the gain coefficient. This results in lower noise suppression. For the time periods where there is no voice or speech this causes a reduction in ERLE performance compared to case where the tuning parameter is set to zero. For the time periods where there is voice or speech this can cause an increase in ERLE performance compared to case where the tuning parameter is set to zero as is shown in FIG. 12B.

A fifth plot 1209 is obtained with the tuning parameter set to minus two (α=−2). This adjusts the gain coefficient predicted by the machine learning program 205 to decrease the gain coefficient. This results in higher noise suppression. For the time periods where there is no voice or speech this causes an increase in ERLE performance compared to case where the tuning parameter is set to zero. For the time periods where there is voice or speech this can cause a reduction in ERLE performance compared to case where the tuning parameter is set to zero as is shown in FIG. 12B.

FIGS. 12A and 12B show that the best performing tuning parameter can be different for different time frames. Therefore, examples of the disclosure can provide for improved performance by changing the values of the tuning parameters so that different values are applied to different time frames.

FIGS. 13A and 13B show different predicted gain coefficients for different tuning parameters.

Examples of the disclosure can be used to predict gain coefficients for different target objectives by changing the tuning parameters that are used and without having to retrain the machine learning program 205. For instance, a machine learning program 205 can be trained with three different objective functions such as

$$\begin{matrix}1. {min}_{w} {f}_{1} ( w , β = 0.25 ) \\ 2. {min}_{w} {f}_{1} ( w , β = 0.5 ) \\ 3. {min}_{w} {f}_{1} ( w , β = 0.75 )\end{matrix}$$

Each of these objective functions could be associated with different target criteria with a trade-off between maximising noise suppression and minimising speech distortion.

The machine learning program is trained or configured to provide two outputs for the respective frequency bands using the formulas given above, or any other suitable formulas, in which β₁=0.25 and β₂=0.75.

The following tuning parameters could then be used to predict gain coefficients for the different target objectives
1. α_{k,f}=1
2. α_{k,f}=0
3. α_{k,f}=−1

FIG. 13A shows the predicted gain coefficients that can be obtained using the different tuning parameters for a first time frame and FIG. 13B shows the predicted gain coefficients that can be obtained using the different tuning parameters for a second, different time frame.

FIGS. 13A and 13B show that predictions of the gain coefficients obtained using examples of the disclosure are good approximations of gain coefficients that would be obtained by a machine learning program 205 that was trained specifically for a single target objective.

Specifically, a single output machine learning program 205 optimized with above mentioned objective 1 or 2 or 3, gives the same prediction as a multi-output machine learning program 205 according to examples of the disclosure which is configured with a tuning parameter value α=1 or α=0 or α=−1, respectively. This confirms that the examples of the disclosure enable configuring of a machine learning program 205 to provide a plurality of outputs while an optimization objective can be changed by changing a tuning parameter of a post-processing step.

FIG. 14 schematically illustrates an apparatus 1401 that can be used to implement examples of the disclosure. In this example the apparatus 1401 comprises a controller 1403. The controller 1403 can be a chip or a chip-set. In some examples the controller can be provided within a computer or other device that can be configured to provide signals and receive signals.

In the example of FIG. 14 the implementation of the controller 1403 can be as controller circuitry. In some examples the controller 1403 can be implemented in hardware alone, have certain aspects in software including firmware alone or can be a combination of hardware and software (including firmware).

As illustrated in FIG. 14 the controller 1403 can be implemented using instructions that enable hardware functionality, for example, by using executable instructions of a computer program 1409 in a general-purpose or special-purpose processor 1405 that can be stored on a computer readable storage medium (disk, memory etc.) to be executed by such a processor 1405.

The processor 1405 is configured to read from and write to the memory 1407. The processor 1405 can also comprise an output interface via which data and/or commands are output by the processor 1405 and an input interface via which data and/or commands are input to the processor 1405.

The memory 1407 is configured to store a computer program 1409 comprising computer program instructions (computer program code 1411) that controls the operation of the controller 1403 when loaded into the processor 1405. The computer program instructions, of the computer program 1409, provide the logic and routines that enables the controller 1403 to perform the methods illustrated in FIG. 5 The processor 1405 by reading the memory 1407 is able to load and execute the computer program 1409.

The apparatus 1401 therefore comprises: at least one processor 1405; and at least one memory 1407 including computer program code 1411, the at least one memory 1407 and the computer program code 1411 configured to, with the at least one processor 1405, cause the apparatus 1401 at least to perform:
using a machine learning program to obtain two or more outputs for at least one of a plurality of different frequency bands;
obtaining one or more tuning parameters;
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted by the at least one uncertainty value and the one or more tuning parameters; and
wherein the adjusted gain coefficient is configured to be applied to a signal associated with at least one microphone output signal within the at least one of the plurality of different frequency bands to control noise suppression for speech audibility.

As illustrated in FIG. 14 the computer program 1409 can arrive at the controller 1403 via any suitable delivery mechanism 1413. The delivery mechanism 1413 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1409. The delivery mechanism can be a signal configured to reliably transfer the computer program 1409. The controller 1403 can propagate or transmit the computer program 1409 as a computer data signal. In some examples the computer program 1409 can be transmitted to the controller 1403 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 1409 comprises computer program instructions for causing an apparatus 1401 to perform at least the following:
using a machine learning program to obtain two or more outputs for at least one of a plurality of different frequency bands;
obtaining one or more tuning parameters;
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted by the at least one uncertainty value and the one or more tuning parameters; and
wherein the adjusted gain coefficient is configured to be applied to a signal associated with at least one microphone output signal within the at least one of the plurality of different frequency bands to control noise suppression for speech audibility.

The computer program instructions can be comprised in a computer program 1409, a non-transitory computer readable medium, a computer program product, a machine readable medium. In some but not necessarily all examples, the computer program instructions can be distributed over more than one computer program 1409.

Although the memory 1407 is illustrated as a single component/circuitry it can be implemented as one or more separate components/circuitry some or all of which can be integrated/removable and/or can provide permanent/semi-permanent/dynamic/cached storage.

Although the processor 1405 is illustrated as a single component/circuitry it can be implemented as one or more separate components/circuitry some or all of which can be integrated/removable. The processor 1405 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software can not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The apparatus 1401 as shown in FIG. 14 can be provided within any suitable device. In some examples the apparatus 1401 can be provided within an electronic device such as a mobile telephone, a teleconferencing device, a camera, a computing device or any other suitable device.

The blocks illustrated in FIG. 3 can represent steps in a method and/or sections of code in the computer program 1409. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus, comprising:
at least one processor; and
at least one non-transitory memory storing instructions that, when executed with the at least one processor, cause the apparatus at least to:
use a machine learning program to obtain two or more outputs for at least one of a plurality of different frequency bands;
obtain one or more tuning parameters; and
process the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted with the at least one uncertainty value and the one or more tuning parameters;
wherein the adjusted gain coefficient is configured to be applied to a signal associated with at least one microphone output signal within the at least one of the plurality of different frequency bands to control noise suppression for speech audibility.

2. An apparatus as claimed in claim 1, wherein the instructions, when executed with the at least one processor, target different output objectives for the two or more outputs.

3. An apparatus as claimed in claim 2, wherein the two or more outputs of the machine learning program comprise gain coefficients that correspond to the two or more output objectives.

4. An apparatus as claimed in claim 1, wherein the instructions, when executed with the at least one processor, cause the apparatus to adjust noise reduction relative to speech distortion.

5. An apparatus as claimed in claim 1, wherein the signal comprises at least one of: speech; or noise.

6. An apparatus as claimed in claim 1, wherein the instructions, when executed with the at least one processor, target different output objectives for the two or more outputs using different functions corresponding to the different output objectives wherein the different functions comprise different values for one or more objective weight parameters.

7. An apparatus as claimed in claim 6, wherein the instructions, when executed with the at least one processor, cause a first value for the one or more objective weight parameters to prioritize noise reduction over avoiding speech distortion and causes a second value for the one or more objective weight parameters to prioritize avoiding speech distortion over noise reduction.

8. An apparatus as claimed in claim 1, wherein the instructions, when executed with the at least one processor, determine the gain coefficient based on a mean of the two or more outputs of the machine learning program and the at least one uncertainty value.

9. An apparatus as claimed in claim 1, wherein the at least one uncertainty value is based on a difference between two or more outputs of the machine learning program.

10. An apparatus as claimed in claim 1, wherein the instructions, when executed with the at least one processor, cause the one or more tuning parameters to control one or more variables of the adjustment used to determine the gain coefficient.

11. An apparatus as claimed in claim 1, wherein the adjustment of the gain coefficient with the at least one uncertainty value and the one or more tuning parameters comprises a weighting of the two or more outputs of the machine learning program.

12. An apparatus as claimed in claim 1, wherein the instructions, when executed with the at least one processor, use different tuning parameters for different frequency bands.

13. An apparatus as claimed in claim 1, wherein the instructions, when executed with the at least one processor, use different to parameters for different time intervals.

14. An apparatus as claimed in claim 1, wherein the instructions, when executed with the at least one processor, cause the machine learning program to receive a plurality of inputs, for one or more of the plurality of different frequency bands, wherein the plurality of inputs comprise any one or more of: an acoustic echo cancellation signal; a loudspeaker signal; a microphone signal; or a residual error signal.

15. An apparatus as claimed in claim 1, wherein the machine learning program comprises a neural network circuit.

16. An apparatus as claimed in claim 1, wherein the instructions, when executed with the at least one processor, cause the apparatus to adjust the tuning parameter based on any one or more of; a user input; a determined use case; a determined change in echo path; determined acoustic echo cancellation measurements; wind estimates; signal noise ratio estimates; spatial audio parameters; voice activity detection; non linearity estimation; or clock drift estimations.

17. An apparatus as claimed in claim 1, wherein the instructions, when executed with the at least one processor, cause the apparatus to use the machine learning program to obtain two or more outputs for the plurality of different frequency bands.

18. An apparatus as claimed in claim 1, wherein the signal associated with at least one microphone output signal comprises at least one of: a raw at least one microphone output signal; a processed at least one of microphone output signal; or a residual error signal.

19. An apparatus as claimed in claim 1, wherein the signal associated with at least one microphone output signal is a frequency domain signal.

20. (canceled)

21. A method, comprising:
using a machine learning program to obtain two or more outputs for at least one of a plurality of different frequency bands;
obtaining one or more tuning parameters; and
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted with the at least one uncertainty value and the one or more tuning parameters;
wherein the adjusted gain coefficient is configured to be applied to a signal associated with at least one microphone output signal within the at least one of the plurality of different frequency bands to control noise suppression for speech audibility.

22-23. (canceled)

24. A non-transitory program storage device readable with an apparatus, tangibly embodying a program of instructions executable with the apparatus for performing operations, the operations comprising:
using a machine learning program to obtain two or more outputs for at least one of a plurality of different frequency bands;
obtaining one or more tuning parameters; and
processing the two or more outputs to determine at least one uncertainty value and a gain coefficient for the at least one of the plurality of different frequency bands, wherein the at least one uncertainty value provides a measure of uncertainty for the gain coefficient, and wherein the gain coefficient is adjusted with the at least one uncertainty value and the one or more tuning parameters;
wherein the adjusted gain coefficient is configured to be applied to a signal associated with at least one microphone output signal within the at least one of the plurality of different frequency bands to control noise suppression for speech audibility.
